(19) United States
(12) Patent Application Publication
(10) Pub. No.: US 2007/0105601 A1
(43) Pub. Date: May 10, 2007

(54) Speaker unit for a communication system

(75) Inventors: Terence A. Ibbetson, Surrey (CA); Marcin C. Cichy, Surrey (CA)

Correspondence Address: NORMAN M. CAMERON, SUITE 1401 - 1166 ALBERNI STREET, VANCOUVER, BC, V6E 3Z3, CA

(73) Assignee: CON-SPACE Communications Ltd.

(21) Appl. No.: 11/590,750

(22) Filed: Nov. 1, 2006

(30) Foreign Application Priority Data
Nov. 4, 2005 (CA) 2,525,609

(51) Int. Cl. H04M 1/00; H04R 1/10

(52) U.S. Cl. 455/575.2; 381/74; 381/123; 381/376

(57) ABSTRACT

A speaker unit for a communications system includes a housing having a front and a back. The front has a plurality of spaced-apart recesses. A circuit board is fitted to the back of the housing. There is a push to talk switch mounted on the circuit board. There is a grill having a plurality of outwardly extending tabs. The tabs slidably engaged in the recesses of the housing to permit the grill to move in a direction extending between the front and the back of the housing. One of the tabs of the grill contacts the push to talk switch, whereby pushing the grill towards the back of the housing actuates the switch. There is an annular retainer fitted over the grill to retain the grill on the housing.

### BACKGROUND OF THE INVENTION

This invention relates to communications systems and, in particular, to communication systems for use with protective clothing for persons exposed to biochemical hazards.

Communications systems have been developed for persons wearing protective clothing adapted for biochemical hazards. Such persons typically wear protective face masks which inhibit normal speech communication with adjacent people. One approach has been to provide persons wearing such clothing with throat microphones or facemask microphones connected to chest-mounted speakers. The persons wearing the protective clothing can therefore be heard by adjacent people.

However, it is often desirable for people wearing such protective clothing to communicate with more remote persons by way of two-way radios or other RF devices. For this reason the chest-mounted speakers may have switches which are actuated so that signals from the microphone are routed to either the speaker or the RF device. In the past however it has been awkward to actuate the switches, particularly using protective gloves typically included with the protective clothing.

U.S. patent application No. 2002/0107053 to Petez, published Aug. 8, 2002, discloses a push to talk (PTT) transceiver that includes a mount assembly with a shell and a speaker/mike assembly. The speaker/mike assembly includes a speaker and a microphone, which are both contained in the shell. The PTT transceiver also includes a two-way radio with a manually operated PTT switch. When the switch is operated, the speaker is not energized and sounds picked up by the microphone are broadcast to other transceivers. When the PTT switch is not operated, any sound at the microphone will not be transmitted over radio waves, but the speaker will generate sounds for the ear representing radio waves that have been detected by the two-way radio.

U.S. Pat. No. 4,491,699 to Walker discloses a dual communication system including a mask microphone for use by a wearer of a protective facemask. An output signal from the microphone is communicated to both a speaker system for local, audible broadcast and to a transmitter for remote broadcast by radio signal. A jack plugged into a switching jack permits communication of the open signal from the mask microphone to the transmitter, while simultaneously providing the open signal to the speaker system. A selector switch selectively curtails radio transmissions from the transmitter, while still permitting the user to receive radio signals by the receiver of the transceiver.

U.S. Pat. No. 5,566,362 to Bauer discloses a voice transmission system for a protective face mask which includes a voice transmitter attached to an external portion of the face mask. The transmitter includes a microphone which converts the sound energy from the wearer of the face mask into an electrical signal that the transmitter communicates via short-range radio signal to a receiver.

U.S. Pat. No. 5,990,793 to Bieback discloses an integrated safety and communication system for attachment to a standard type of firefighter's face mask. The communication system includes a transceiver, a speaker, an electronics package, which includes an audio amplifier, and an on/off switch to enable or energize the amplifier-speaker unit. There is also a transceiver for communication with a command post transceiver.

### SUMMARY OF THE INVENTION

According to one aspect of the invention there is provided a speaker unit for a communication system. The unit includes a housing with a loudspeaker being mounted on the housing. A grill is mounted on the housing over the loudspeaker. A switch is mounted on the housing. The grill operatively engages the switch whereby manually contacting the grill operates the switch. In one example the housing has a front and the grill is mounted on the front of the housing. The grill is movable to operate the switch by manually pushing the grill.

According to another aspect of the invention there is provided a communication system with a microphone, an RF transmitter and a speaker unit. The speaker unit includes a housing, a loudspeaker mounted on the housing, a grill mounted on the housing over the speaker and a switch mounted on the housing. The grill operatively engages the switch whereby manually contacting the grill operates the switch. Conductors connect the microphone, the RF transmitter and the speaker unit. Operation of the switch by movement of the grill connects the microphone alternatively to the RF transmitter or the loudspeaker.

According to a further aspect of the invention there is provided a speaker unit for a communications system. The unit includes a housing having a front and a back. The front has a plurality of spaced-apart recesses. A circuit board is fitted to the back of the housing. There is a push to talk switch mounted on the circuit board. There is a grill having a plurality of outwardly extending tabs. The tabs slidably engage the recesses of the housing to permit the grill to move in a direction extending between the front and the back of the housing. One of the tabs of the grill contacts the push to talk switch, whereby pushing the grill towards the back of the housing actuates the switch. There is an annular retainer fitted over the grill to retain the grill on the housing.

### BRIEF DESCRIPTION OF THE DRAWINGS

Referring to the drawings:

FIG. 1 is a block diagram of a communication apparatus according to an embodiment of the invention;

FIG. 2 is a front view of the housing for the chest speaker assembly thereof;

FIG. 3 is a sectional view taken a long line 3-3 of FIG. 2;

FIG. 4 is an exploded view of the chest speaker assembly;

FIG. 5 is a front view of the chest speaker assembly with the push-to-talk switch in the deactivated position;

FIG. 6 is a sectional view taken a long line 6-6 of FIG. 5;

FIG. 7 is a view similar to FIG. 5 with the switch in the activated position;

FIG. 8 is a sectional view taken a long line 8-8 of FIG. 7; and

FIG. 9 is a fragmentary perspective view of the person wearing protective clothing and fitted with a communication apparatus according to an embodiment of the invention.

### DETAILED DESCRIPTION OF THE PREFERRED EMBODIMENT

Referring to the drawings, and first to FIG. 9, this shows a person 12 wearing a biochemical suit 14 of the type worn during biochemical emergency situations. For example the person could be employed to deal with patients who have been exposed to a biochemical hazard and to decontaminate such patients before they are admitted to a hospital where they could potentially contaminate other patients or hospital staff as well as the hospital premises. In such a situation the person 12 is protected from the biochemical hazard by the suit 14 including a face mask 16. However it is difficult for the person to communicate with patients and personnel within the hospital while wearing the suit 14, particularly with the mask 16.

For this reason communications systems have been developed which include a throat mike 20 of the well-known type available, for example, from Con-Space Communications at www.con-space.com as Part No. 1303-02-011. Alternatively, other types of throat mikes or other transducers capable of converting the human voice to suitable electrical signals could be substituted.

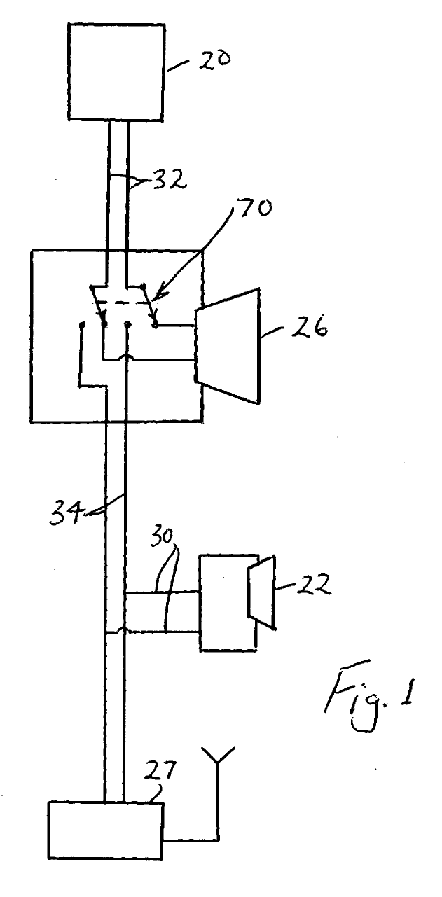

The person 12 is shown wearing an earpiece speaker 22 for monitoring incoming messages from a two-way radio 27, shown in FIGS. 1 and 9, or another RF device. There is also a chest speaker assembly 24 which includes a chest speaker 26, shown in FIG. 1, whereby the person 12 can communicate with nearby persons via the throat mike 20. The earpiece speaker 22 is connected to the throat mike by conductors 30. Conductors 32 connect the throat mike to the chest speaker assembly. Conductors 34, shown in FIGS. 1 and 9, connect the chest speaker to the two-way radio 27. It should be understood that other wiring configurations are possible or the various devices could be connected by wireless communications systems such as Bluetooth. As described thus far, the apparatus is generally conventional and accordingly is not described in more detail.

In conventional apparatuses of the general type the chest speaker assembly is provided with a PTT switch 70 which enables the person to communicate either to adjacent persons via speaker 26 or to, for example, remotely located persons such as other hospital personnel, via the two-way radio 27. However it is cumbersome for the person to operate such a switch while wearing protective clothing, particularly while wearing gloves 40.

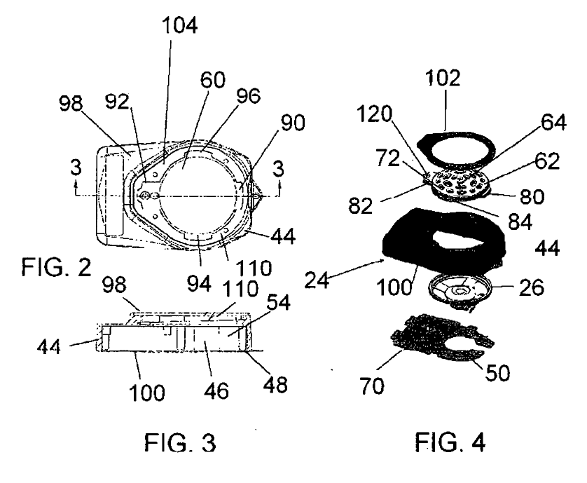

The invention overcomes problems associated with prior art apparatuses by including an improved chest speaker assembly 24 as shown in better detail in FIGS. 2-8. The assembly includes a housing 44 which in this embodiment is of plastic although alternatively it could be of metal or other materials. The housing includes a generally rectangular rear cavity 46 with a recess 48 extending about the periphery thereof for receiving a PC board 50. A circular cavity 54 extends inwardly from the cavity 46 and receives the speaker 26. The housing has a circular aperture 60 which exposes the speaker to speaker grill 62 having a plurality of apertures 64 to allow acoustical signals to be transmitted to adjacent persons. This general arrangement is common in earlier speaker assemblies.

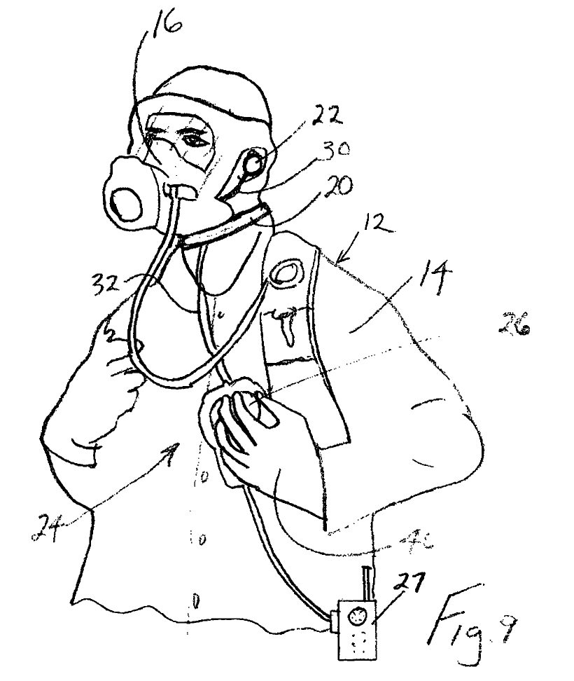

The speaker assembly 24 however is unique in that speaker grill 62 is used to activate push to talk (PTT) switch 70 which in this example is mounted on the PC board 50 as shown in FIGS. 4, 6 and 8. The grill in this example has a generally circular body 72 with a plurality of tabs extending radially outwards therefrom. Three of these tabs are visible in FIG. 8 including top tab 80, bottom tab 82 and one side tab 84. The grill has a second side tab extending on the side opposite tab 84 although not shown in the drawings.

The housing has generally rectangular recesses 90, 92, 94 and 96 for respectively receiving the tabs 80, 82, 84 and the other side tab not shown. The recesses are larger than the tabs, allowing movement of the grill in a direction extending from front 98 to rear 100 of the housing. An annular grill retainer 102 is press fitted into a complementary-shaped recess 104 on the housing to prevent the grill from being dislodged from the housing, but allowing limited movement of the grill between the retainer 102 and face 110 of the housing.

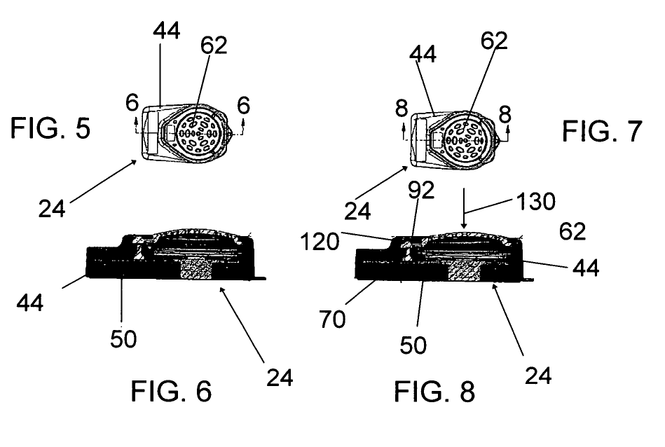

The tab 82 is provided with a dimple 120 having a concave surface facing PTT switch 70 and fitting over the switch. When the grill is released, as shown in FIGS. 5 and 6, the switch is deactivated and acoustical signals from the throat mike 20 are routed to the speaker 26. However when the person wishes to communicate with others via two-way radio 27 shown in FIG. 1, the person presses on the grill 26 as illustrated in FIG. 9 and by arrow 130 in FIG. 8. This causes the grill, in particular tab 92 thereof, to press the PTT switch 70 at dimple 120. The switch then routes electrical signals from the throat mike to the two-way radio 27 shown in FIG. 1.

It will be understood by someone skilled in the art that many of the details provided above are by way of example only and are not intended to limit the scope of the invention which is to be determined with reference to the following claims.

What is claimed is:

1. A speaker unit for a communication system, the unit comprising:
a housing;
a loudspeaker mounted on the housing;
a grill mounted on the housing over the loudspeaker; and
a switch mounted on the housing, the grill operatively engaging the switch whereby manually contacting the grill operates the switch.

2. The speaker unit as claimed in claim 1, wherein the housing has a front and the grill is mounted on the front of the housing, the grill being movable to operate the switch by manually pushing the grill.

3. A communications system comprising:
a microphone;
an RF transmitter;
a speaker unit including a housing, a loudspeaker mounted on the housing, a grill mounted on the housing over the speaker and a switch mounted on the housing, the grill operatively engaging the switch whereby manually contacting the grill operates the switch; and
conductors connecting the microphone, the RF transmitter and the speaker unit, whereby operation of the switch by the movement of the grill connects the microphone alternatively to the RF transmitter or the loudspeaker.

4. The communications system as claimed in claim 3, wherein the housing has a front and the grill is mounted on the front of the housing, the grill being movable to operate the switch by manually pushing the grill.

5. A speaker unit for a communication system, the unit comprising:
a housing having a front and a back, the front having a plurality of spaced-apart recesses;
a circuit board fitted to the back of the housing;
a push to talk switch mounted on the circuit board;
a grill having a plurality of outwardly extending tabs, the tabs slidably engaging the recesses of the housing to permit the grill to move in a direction extending between the front and the back of the housing, one of the tabs of the grill contacting the push to talk switch, whereby pushing the grill towards the back of the housing actuates the switch; and
an annular retainer fitted over the grill to retain the grill on the housing.
